(19) United States
(12) Patent Application Publication
(10) Pub. No.: US 2012/0238753 A1
(43) Pub. Date: Sep. 20, 2012

(54) PROCESS FOR THE PREPARATION OF ADEFOVIR DIPIVOXIL

(76) Inventors: Siva Rama Prasad VELLENKI, Hyderabad (IN); Madhu Murthy Nadella, Hyderabad (IN); Rajendar Reddy Mullamalla, Hyderabad (IN); Venkata Siva Reddy Arumalla, Hyderabad (IN); Ravindra Pulyala, Hyderabad (IN)

(21) Appl. No.: 13/418,590

(22) Filed: Mar. 13, 2012

(30) Foreign Application Priority Data
Mar. 14, 2011 (IN) 756/CHE/2011

(51) Int. Cl. C07F 9/6561

(52) U.S. Cl. 544/244

(57) ABSTRACT

An improved process for the preparation of adefovir dipivoxil and its pharmaceutically acceptable salts or solvates comprises the condensation of adefovir with chloro methyl pivalate in a mixture of two or more solvents in the presence of a base and isolating the resulting adefovir dipivoxil.

### FIELD OF THE INVENTION

The present invention relates to an improved process for the preparation of adefovir dipivoxil. The contents of India provisional patent specification 756/CHE/2011 filed Mar. 14, 2011 is incorporated herein by reference.

### BACKGROUND OF THE INVENTION

Adefovir dipivoxil is a diester prodrug of adefovir. Adefovir dipivoxil is an orally-administered nucleotide analog reverse transcriptase inhibitor (ntRTI) used for treatment of hepatitis B. Defovir dipivoxil (9- [2-[[bis[(pivaloyloxy)methoxy]phosphiny]-methoxy]ethyl]adenine) having Formula-I is more suitable for developing formulations and has been recommended as a drug.

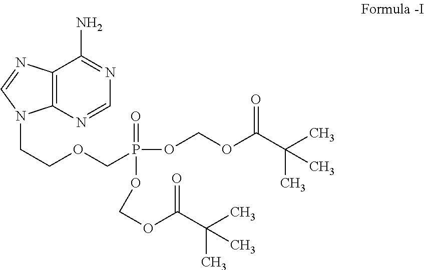

Adefovir dipivoxil and processes for the preparation of the same are described in U.S. Pat. No. 5,663,159. The process of U.S. Pat. No. 5,663,159 is disclosed in the following scheme-I:

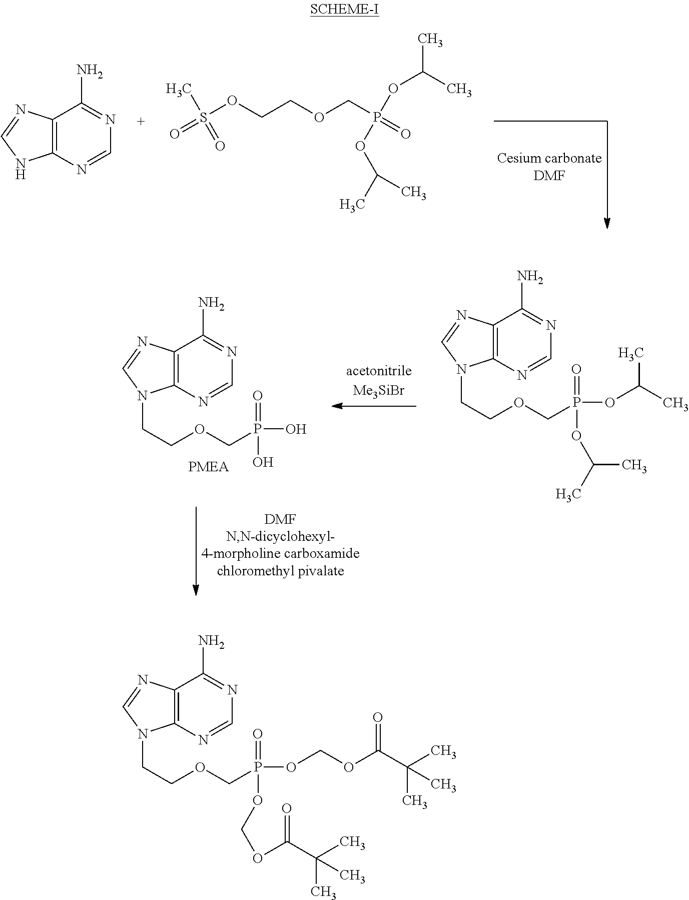

U.S. Pat. No. 6,451,340 discloses various crystalline salts of Adefovir dipivoxil. This patent also discloses a process for the preparation of Adefovir dipivoxil as disclosed in scheme II:

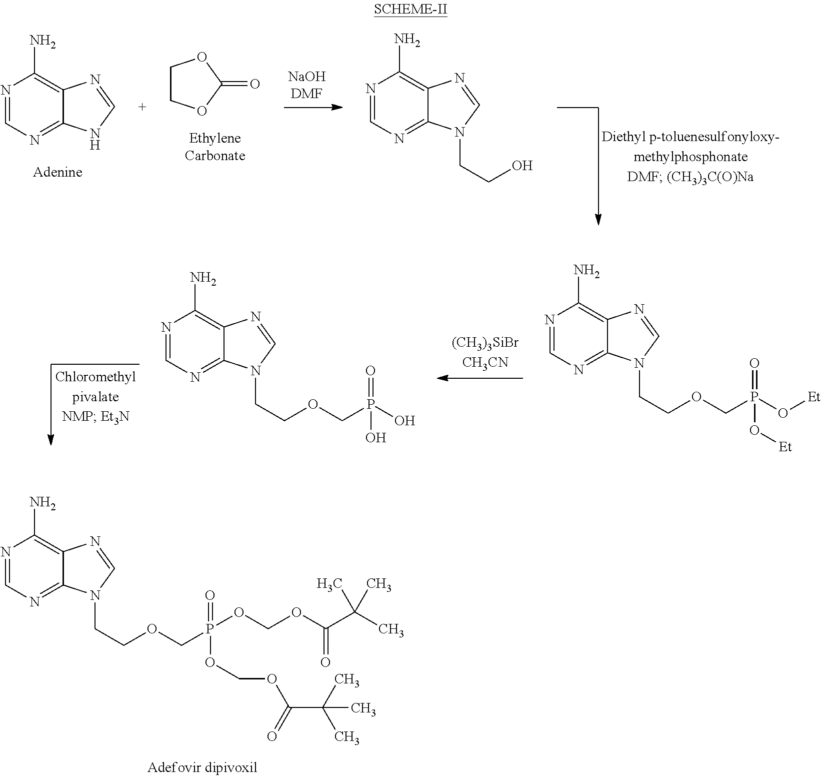

Still there is a need in the art to provide a process for the preparation of Adefovir dipivoxil with improved yield and quality. Thus the present invention provides an improved process for the preparation of adefovir dipivoxil.

### OBJECT AND SUMMARY OF THE INVENTION

The principal object of the present invention is to provide an improved process for the preparation of adefovir dipivoxil from (2-(6-amino-9H-purin-9-yl)ethoxy)methylphosphonic acid (adefovir) by using a mixture of solvents.

Another object of the present invention is to provide a novel process for the preparation of (2-(6-amino-9H-purin-9-yl)ethoxy)methylphosphonic acid (adefovir).

Yet another object of the present invention is to provide an improved process for the preparation of (2-(6-amino-9H-purin-9-yl)ethoxy)methylphosphonic acid (adefovir) by dealkylating corresponding alkyl esters using mineral acids.

### DETAILED DESCRIPTION OF THE INVENTION:

The present invention relates to an improved process for the preparation of adefovir dipivoxil from (2-(6-amino-9H-purin-9-yl)ethoxy)methylphosphonic acid (adefovir) by using a mixture of solvents. The present invention further relates to a process for the preparation of (2-(6-amino-9H-purin-9-yl)ethoxy)methylphosphonic acid (adefovir) by dealkylating corresponding alkyl esters using mineral acids.

The main aspect of the present invention is to provide an improved process for the preparation of adefovir dipivoxil comprising the steps of:
a) condensing (2-(6-amino-9H-purin-9-yl)ethoxy)methylphosphonic acid (adefovir) with chloro methyl pivalate in a mixture of two or more solvents in presence of a base; and
b) isolating adefovir dipivoxil.

In one embodiment, the solvent mixture is selected from polar solvents and non-hydroxylic solvents. The polar solvent is selected from N,N-dimethylacetamide, N,N-dimethylformamide and dimethylsulfoxide, and is preferably N,N-dimethylacetamide. The non-hydroxylic solvent is selected from ethylacetate and tetrahydrofuran, and is preferably ethylacetate. Preferably the mixture used for the reaction is N,N-dimethylacetamide and ethyl acetate.

In one more embodiment, the base used in this reaction is selected from an organic base such as trialkylamine. The trialkylamine base used is triethylamine.

In another embodiment, condensation of (2-(6-amino-9H-purin-9-yl)ethoxy)methylphosphonic acid (adefovir) with chloro methyl pivalate is carried out optionally in the presence of a phase transfer catalyst. The phase transfer catalyst is selected from tetramethyl ammonium bromide, tetrabutyl ammonium bromide, methyl triethyl ammonium bromide, benzyl trimethyl ammonium bromide, benzyl triethyl ammonium bromide and crown ethers, and is preferably tetrabutyl ammonium bromide.

One more aspect of the present invention is to provide a novel process for the preparation of (2-(6-amino-9H-purin-9-yl)ethoxy)methylphosphonic acid (adefovir) comprising the steps of:
a) reacting adenine with dialkyl (2-chloroethoxy) methyl phosphonate in presence of a base in a polar solvent;
b) dealkylating the obtained dialkyl (2-(6-amino-9H-purin-9-yl)ethoxy)methylphosphonate with mineral acid; and
c) isolating adefovir.

In one embodiment, the polar solvent used in the present invention is selected from dimethylformamide and dimethyl sulfoxide, and is preferably dimethylformamide.

In another embodiment, the base used in the present invention is selected from potassium carbonate and sodium carbonate, and is preferably potassium carbonate.

In one more embodiment, the mineral acid used in the present invention for the dealkylation is selected from aq HCl and aq HBr, and is preferably aq HBr.

In one more embodiment, the alkyl is a C₁-C₆ alkyl group such as methyl, ethyl or isopropyl, and preferably ethyl.

In one more embodiment, the adefovir obtained in the present invention is converted into adefovir dipivoxil and its pharmaceutically acceptable salts or solvates by conventional methods, for example as disclosed in U.S. Pat. No. 5,663,159 and U.S. Pat. No. 6,451,340.

One more aspect of the present invention is to provide a process for the preparation of adefovir dipivoxil formic acid solvate, comprising the steps of:
a) dissolving adefovir dipivoxil in an ester solvent;
b) adding formic acid to the obtained solution; and
c) isolating adefovir dipivoxil formic acid solvate.

In one embodiment, the ester solvent is selected from ethyl acetate or isopropyl acetate, and is preferably ethyl acetate.

Apart from ester solvents, ketonic solvents such as acetone and methylethylketone, preferably acetone; chlorinated solvents such as dichloromethane and chloroform, preferably dichloromethane; ethers such as diethylether, diisopropylether and tetrahydrofuran, and preferably tetrahydrofuran; and hydrocarbon solvents such as toluene and hexane, preferably toluene, can also be used for the preparation of adefovir dipivoxil formic acid solvate.

As per the present invention, adefovir dipivoxil is dissolved in an ester solvent such as ethyl acetate or isopropyl acetate, and preferably ethyl acetate, at a temperature of 35-45° C., preferably 38-43° C. to get a clear solution. The reaction mass is filtered and optionally cooled to 20-30° C., preferably 22-27° C. To this formic acid is added, stirred for 2-3 hours and filtered. The filtered material is washed with ethyl acetate and dried to get adefovir dipivoxil formic acid solvate.

The following examples are provided for illustrative purposes only and are not intended to limit the scope of the invention in any way.

Experimental Procedure:

### EXAMPLE—1

### Process for the Preparation of Adefovir

Adenine (100 gm) was taken in a round bottom flask, and to this potassium carbonate (122.8 gm) was added. The resulting mixture was suspended in dimethyl formamide (800 ml) at 25- 35 ° C. and stirred for 1 hour at 80-85° C. To this diethyl (2-chloroethoxy) methyl phosphonate solution (170.7 gm diluted in 100 ml dimethylformamide) was added and stirred for 20 hours. The reaction mass was cooled to room temperature and filtered. The wet cake was washed with dimethyl formamide (100 ml). The filtrate was taken into another flask and the solvent was distilled off completely under vacuum. The obtained residue was cooled and aq.hydrobromic acid (680 gm) was added. The temperature was raised to 90-95° C. and stirred for 4 hours. To this purified water (600 ml) and methylene chloride (100 ml) was added at a temperature of 25-35° C. The aqueous layer was separated and pH adjusted to 2.8 with a sodium hydroxide solution. The reaction mass was cooled to 5° C. and filtered. The cake was washed with water stirred at 90-95° C. for 1 hour. The reaction mass was cooled to 25-35° C. and filtered. The resultant cake was washed with water and dried to yield adefovir (80 gm).

### EXAMPLE—2

### Process for the Preparation of Adefovir Dipivoxil

Adefovir (100 gm) was taken in a flask and to this a mixture of N,N-dimethylacetamide (225 ml) and ethyl acetate (75 ml) was added. To this triethyl amine (111 gm) and tetra butyl ammonium bromide (30 gm) was added and stirred at 25-35° C. for 1 hour. The temperature was raised to 54-56° C. To this chloromethyl pivalate (275.6 gm) was added and the reaction mass was cooled to 25-35° C. To the reaction mass ethyl acetate (400 ml) was added and filtered. The filtrate was taken into another flask and to this water was added. The ethyl acetate layer was separated and washed with purified water. The ethyl acetate layer was dried under anhydrous sodium sulphate and the ethyl acetate layer distilled under vacuum. To this methyl-tert butyl ether (300 ml) was added and the reaction mass was cooled to 0-5° C. This was washed with chilled ethyl acetate and MTBE mixture. The compound was suck dried to yield adefovir dipivoxil.

### EXAMPLE—3

### Process for the Preparation of Adefovir Dipivoxil Formic Acid Solvate

Adefovir dipivoxil (100 gm) was added to ethyl acetate (800 ml) and heated to 40±2° C. The reaction mass was cooled to room temperature and formic acid (18.4 gm) was added. The obtained solid was filtered and dried to yield adefovir dipivoxil formic acid solvate.

We claim:

1. A process for the preparation of adefovir dipivoxil, comprising the steps of:
a) condensing (2-(6-amino-9H-purin-9-yl)ethoxy)methylphosphonic acid (adefovir) with chloro methyl pivalate in a mixture of two or more solvents in the presence of a base; and
b) isolating adefovir dipivoxil.

2. The process according to claim 1, wherein the solvent mixture is selected from mixtures of polar solvents and non-hydroxylic solvents.

3. The process according to claim 2, wherein the polar solvent is selected from N,N-dimethylacetamide, N,N-dimethylformamide and dimethylsulfoxide.

4. The process according to claim 2, wherein the non-hydroxylic solvent is selected from ethylacetate and tetrahydrofuran.

5. The process According to claim 1, wherein the solvent mixture is a mixture of N,N-dimethylacetamide and ethyl acetate.

6. The process according to claim 1, wherein the base is triethylamine.

7. The process according to claim 1, wherein the condensation of adefovir with chloro methyl pivalate is carried out in the presence of a phase transfer catalyst.

8. The process according to claim 7, wherein the phase transfer catalyst is selected from tetramethyl ammonium bromide, tetrabutyl ammonium bromide, methyl triethyl ammonium bromide, benzyl trimethyl ammonium bromide, benzyl triethyl ammonium bromide and crown ethers.

9. An improved process for the preparation of (2-(6-amino-9H-purin-9-yl)ethoxy)methylphosphonic acid (adefovir) comprising the steps of:
a) dealkylating dialkyl (2-(6-amino-9H-purin-9-1)ethoxy)methylphosphonate with a mineral acid; and
b) isolating adefovir.

10. The process according to claim 9, wherein the mineral acid is selected from aq HCl and aq HBr.

11. The process according to claim 9, wherein the dialkyl (2-(6-amino-9H-purin-9-yl)ethoxy)methylphosphonate is diethyl (2-(6-amino-9H-purin-9-yl)ethoxy)methylphosphonate.

12. The process according to claim 9, wherein the dialkyl (2-(6-amino-9H-purin-9-yl)ethoxy)methylphosphonate is prepared by reacting adenine with dialkyl (2-chloroethoxy) methyl phosphonate in the presence of a base in a polar solvent.

13. The process according to claim 9 wherein the adefovir is further converted into adefovir dipivoxil and its pharmaceutically acceptable salts or solvates.

14. A process for the preparation of adefovir dipivoxil formic acid solvate comprising the steps of:
c) dissolving adefovir dipivoxil in an ester solvent;
d) adding formic acid to the obtained solution; and
e) isolating adefovir dipivoxil formic acid solvate.

15. The process according to claim 14, wherein the ester solvent is selected from ethyl acetate and isopropyl acetate.
